(19) United States
(12) Patent Application Publication
(10) Pub. No.: US 2004/0046639 A1
(43) Pub. Date: Mar. 11, 2004

(54) Device for operating a motor vehicle without a key

(76) Inventors: Elmar Giehler, Stuttgart-Hausen (DE); Achim Wach, Markgroeningen (DE); Karl-Heinz Kaiser, Tamm (DE)

Correspondence Address: KENYON & KENYON, ONE BROADWAY, NEW YORK, NY, 10004, US

(21) Appl. No.: 10/432,066

(22) PCT Filed: Nov. 30, 2001
(86) PCT No.: PCT/DE01/04470

(30) Foreign Application Priority Data
Dec. 2, 2000 (DE) 100 59 991.5

(51) Int. Cl. G06F 7/04

(52) U.S. Cl. 340/5.63; 340/5.61

(57) ABSTRACT

A device according to the present invention is proposed for the keyless operation of a motor vehicle (8), having a transponder (14) that sends a code to at least one transceiver (12). A control unit (10) compares the code to an expected code, and upon agreement, enables at least one component (16, 18) necessary for the operation of the motor vehicle (8), and deactivates it in the shutdown state of the motor vehicle (8). A timer (T2, T3) is provided, whose output value is compared to a specifiable time duration (t2, t3), the at least one component (16, 18) necessary for the operation of the motor vehicle (8) being deactivated when the output value of the timer (T2, T3) exceeds the specifiable time duration (t2, t3).

### FIELD OF THE INVENTION

The present invention relates to a device for the keyless operation of a motor vehicle.

### BACKGROUND INFORMATION

The German Patent Application No. 44 37 334 describes a service-friendly vehicle immobilizer. To permit simple servicing of individual motor functional units, a function control device has a circumvention arrangement which allows an exceptional unlocking of a function control device by an external device. In particular, this may permit simplified servicing, for which a proper enabling of the control devices may not have to be performed. Falling back on the external device may not be practical to ensure a renewed enabling of the motor vehicle in critical situations during normal operation, as well.

### SUMMARY OF THE INVENTION

An object of the present invention may include permitting operation of the motor vehicle in certain situations, without having to put up with losses in security with respect to theft protection.

An exemplary device of the present invention for the keyless operation of a motor vehicle may include a transponder which transmits a code to at least one transceiver. A control unit may compare the code to an expected code, and if they agree, may enable at least one component required for the operation of the motor vehicle. In the shutdown state of the motor vehicle, it may deactivate it. At least one timer may be provided whose output value may be compared to a specifiable time duration, the at least one component required for the operation of the motor vehicle being deactivated when the output value of the timer exceeds the specifiable time duration.

The motor vehicle may be started after a code exchange, recognized as valid, between the transponder and the control unit. If the engine start is only permitted after this code exchange, critical situations may occur for the user of the vehicle in some scenarios if a remedy according to an exemplary embodiment and/or exemplary method of the present invention is not provided. When using an exemplary device of the present invention, after a proper enabling, the vehicle may also be started within a time span when no code, or no expected code, appears via the transceiver. Therefore, a renewed start may also be provided without transponder. If, unnoticed, the transponder becomes lost from the vehicle during the trip, and the driver, for example, stalls the engine at a potentially dangerous location such as a grade crossing, then, even without transponder, the user may restart the vehicle within a predefinable time span without the code agreement, which is required for the first enabling of the vehicle, having to be attained between the transponder and the transceiver. The motor vehicle may be started again by deactivating the component required for operation only after the specifiable time duration, provided no operator action is detected within this time duration.

Understood by deactivation of a component required for operation in connection with a steering wheel lock is the (electromotive) locking of the steering wheel. This locking may also only be performed when the timer has exceeded the specifiable time duration. Within this time duration, the user may still prevent this locking operation by actuating an operating control element such as the accelerator, brake pedal or clutch pedal. Thus, for example, even when the engine is shut down, the motor vehicle may still be rolled safely into the garage without impairing the steering in so doing.

In a further exemplary embodiment, the timer may be started as a function of a sensor signal detecting the state of the driving engine. The engine speed may suitable as a sensor signal to provide information about whether the engine is still running. The timer may be activated with the shutdown of the engine, so that within the time duration beginning then, a renewed proper operation of the motor vehicle may be provided.

An exemplary embodiment may couple the start of the timer with an output signal of an operating control element. User-critical situations may thereby be recognized in a simple manner. Thus, the output signal of the start/stop switch in the form of the signal “ignition on/off” may be linked to the engine speed. If the engine is no longer running, in spite of the signal “ignition on”, one may assume that the driver has stalled the engine. In this case, the timer is started in order to delay the deactivation of the component required for operation, and within this time span, to permit the proper start and operation of the motor vehicle, even without proof of authorization by way of transponder. Therefore, the deactivation may not be performed when a change in an operating-control-element signal infers an operator action within the time span.

According to an exemplary embodiment, when the engine is running, a search signal may be transmitted if the vehicle is standing. The search signal may cause the transponder to send back a response signal which is checked for authorization. The driving authorization is only rechecked in uncritical situations. If the transponder is missing, further suitable actions may be initiated such as the activation of a warning indicator or the blocking of the appropriate control units. The search signal may be transmitted when the vehicle is standing, the clutch is not depressed, no gear is engaged, and the last query is not any longer ago than a specific time span.

### BRIEF DESCRIPTION OF THE DRAWINGS

FIG. 1 shows a block diagram of an exemplary device according to the present invention.

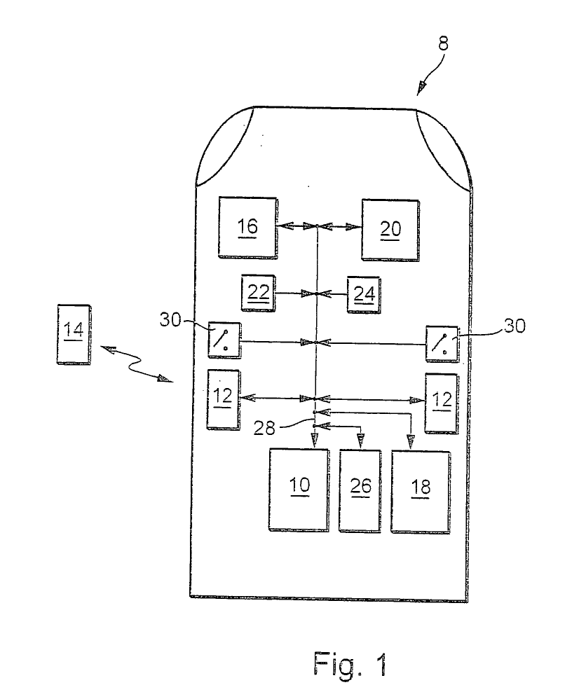

FIG. 2 shows a flowchart for the operation of the exemplary device according to the present invention.

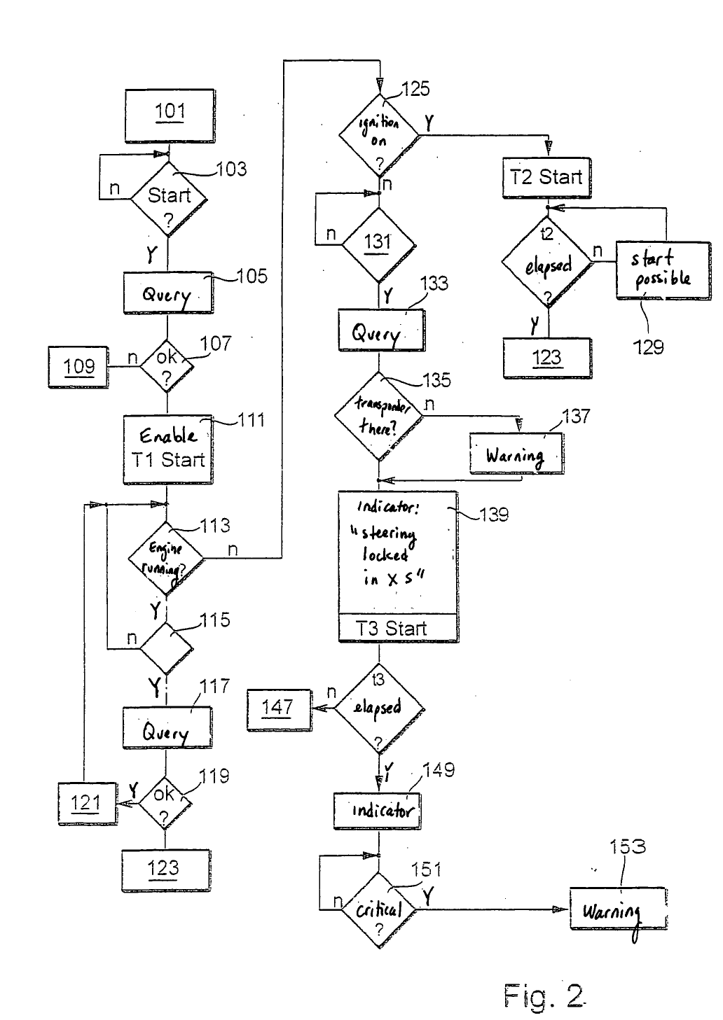

### DETAILED DESCRIPTION

In a motor vehicle 8, a control unit 10 is connected via a bus system 28 to transceivers 12 arranged at the door side areas. Signals from a first and a second operating control element 22, 24 are supplied to bus system 28. A steering wheel lock 16, a function control unit 18, an indicator unit 20, a sensor suite 26, as well as two door monitoring switches 30 are likewise connected to the bus system.

In the following, an operator action for starting and shutting down motor vehicle 8 is described. In a step 101, motor vehicle 8 is shut down and is in its initial state. The intention is to start it. Motor vehicle 8 is properly unlocked, which may likewise be performed via an authorization query with transponder 14. Transponder 14 arrives together with the driver in the passenger compartment of motor vehicle 8. Control unit 10 checks cyclically whether a starting condition is present, query 103. The starting condition is fulfilled when, in a first alternative, both operating control elements 22, 24, disposed spatially at a distance from one another, have been actuated. In this context, first operating control element 22 is a starter switch or starting knob that, for example, is disposed in the center console or in the cockpit area. A pull switch at the transmission selector lever or something similar may also be provided. The clutch pedal, accelerator or brake pedal are considered, for example, as second operating control element 24. The detection of a signal from the hand brake or the gear selection switch may also be provided. First and second operating control elements 22, 24 may be positioned so far from each other that a small child is unable to actuate both operating control elements 22, 24 simultaneously. Namely, in the first alternative, a simultaneous actuation of operating control elements 22, 24 is the prerequisite for fulfilling the starting condition in accordance with query 103. As a second alternative starting condition, one of the two operating control elements 22, 24 is required to have been actuated for a specific time span. Thus, for example, a first operating control element 22, implemented as a starting knob, is required to be held for a second before the starting condition according to query 103 is fulfilled. Only then is the authorization query according to step 105 performed.

To that end, transceiver 12 transmits a search signal which is received by transponder 14 when it is located in the passenger compartment of motor vehicle 8. If transponder 14 receives the transmitted search signal, it sends back a code. This code is acquired by transceiver 12 and is compared in control unit 10 to an expected code. If they agree—thus if the authorization query was run through successfully according to query 107—step 111 follows. The search signal sent out during the authorization query according to step 105 may also be an energy signal, which causes transponder 14 to send back a code. The authorization query according to step 105 may also be even further encoded, to prevent manipulation attempts. For example, the encoding may be effected according to an alternating code method, in which in response to each query, transponder 14 sends back a different signal. If several transponders 14 are used (for several motor-vehicle users), a query according to a so-called time-slot method may be expedient. Each transponder 14 may be assigned a characteristic time slot, within which it sends back a code. Based on the time delay between the transmission of a search signal and the receipt of the code, control unit 10 recognizes which transponder 14 is located in the passenger compartment of motor vehicle 8. For each of these transponders identifiable based on the time slot, a different code may be stored. Control unit 10 thereupon causes transceiver 12 to transmit a code, assigned to this transponder 14, which may be subsequently sent back by transponder 14, processed according to a predefined algorithm. Control unit 10 compares the incoming transponder signal to an expected response signal, which was calculated in the same manner in control unit 10.

However, if the code sent by transponder 14 does not agree with the code expected by control unit 10, enablement is not performed, step 109. Otherwise, the engine functions are enabled without restriction, in that control unit 10 sends an enabling code to function control unit 18. Function control unit 18 may only initiate the proper operation after receipt of the enabling code. At the same time, control unit 10 transmits an enabling code to steering wheel lock 16, which is thereupon released, for example, electromotively. Motor vehicle 8 and a first timer T1 are started (step 111).

In query 113, based on the engine speed detected by sensor suite 26, it is checked whether the engine of motor vehicle 8 is still running. If this is the case, in query 115, it is ascertained whether the conditions for the repeated implementation of an authorization query (given a running engine) are present. A check of the driving authorization during the drive is not useful, since the absence of transponder 14 may not lead to any consequences for the continued drive. A check when the engine is running presents itself precisely when all the following conditions are met: motor vehicle 8 is standing (vehicle speed is zero), the clutch is not depressed, no gear is engaged, and first timer T1, which records the time elapsed from the last query, has exceeded a definable limit of, for example, 10 minutes. If all these conditions are met, in step 117, the authorization query is performed again in conformance with step 105. In addition, independently of the conditions according to step 115, the query is activated, for example, every 30 minutes. If the authorization is verified, query 119, first timer T1 is re-started in a step 121, and the program sequence is subsequently continued with query 113. If transponder 14 sends no code, or not the expected code, in step 123, warning indicator 20 is activated, and the shutdown of motor vehicle 8 is optionally prepared. In so doing, control unit 10 activates the vehicle immobilizer function by sending a command to function control unit 18, so that function control unit 18 is no longer able to operate properly. This program sequence during the drive may improve theft protection without, however, leading to a shutdown of the motor vehicle in critical situations. On the other hand, the use of first timer T1 may ensure that transponder 14 is not activated too often along the lines of an authorization query. Its service life may be increased.

If it is determined in query 113 that the engine of motor vehicle 8 has stopped (engine speed equals zero), in query 125, it is ascertained whether the ignition is switched on. This may be done by evaluating the output signal of first operating control element 22, implemented as a start/stop knob. If the engine has stopped in spite of the signal “ignition on”, this may infer that the engine has stalled, thus was stopped unintentionally. In this user-critical situation, it may be required that the driver still be given the possibility of starting motor vehicle 8 again, even without a successful run-through of an authorization query (according to step 105). Therefore, the presence of a (valid) transponder 14 in the passenger compartment may not be required for the repeated start.

On the other hand, to ensure safety against theft, a renewed start without authorization proof (according to step 129) is only allowed for a specifiable second time span t2. To that end, a second timer T2 is started, step 127, whose output signal is compared to specifiable second time span t2 as to whether it has exceeded it, step 128. As long as second timer T2 has not yet exceeded second time span t2, the shutdown of motor vehicle 8 with the associated transmission of a deactivation command to function control unit 14 is not yet performed, so that a new start is readily possible, step 129. Steering wheel lock 16 is also not triggered along the lines of locking. Motor vehicle 8 is shut down after second time span t2 has been exceeded, step 123.

If it was established in query 125 that the engine standstill (query 113) is occurring in conjunction with the signal “ignition off”, then it may be required to assume that the shutdown of motor vehicle 8 was desired by the driver. In subsequent query 131, the conditions for the initiation of an authorization query according to step 133 are checked. If a certain time (e.g. 10 seconds) is exceeded, or door monitoring switches 30 detect an opening of a door, the exchange is performed in step 133 which conforms with step 105. Alternatively, query 131 may be omitted completely, in order to avoid time delays. The authorization query according to step 133 is used for ascertaining whether a transponder 14 is in the passenger compartment, query 135. If no transponder signal arrives at transceiver 12, in step 137, warning indicator 20 is activated to signal to the user that transponder 14 is missing. Otherwise, step 139 follows immediately, in which it is indicated that steering wheel lock 16 will be implemented (including, for example, information as to in how many seconds). Control unit 10 sends to function control unit 18 a deactivation command, which prevents the proper operation of function control unit 18, and therefore activates the vehicle immobilizer. At the same time, a third timer T3 is started.

According to query 145, third timer T3 is monitored for the exceeding of a specifiable third time duration t3. As long as third timer T3 has not yet reached this threshold, steering wheel lock 16 may be forestalled by actuation of second operating control element 24, such as the clutch pedal, brake pedal or accelerator. Thus, for example, with the engine switched off, motor vehicle 8 may still be safely rolled into the garage, step 147.

Otherwise, steering wheel lock 16 is suitably triggered to lock. The user is signaled via indicator 20 that the steering wheel is being locked, step 149. In query 151, the state of motor vehicle 8 is checked for a critical situation. For example, this may be the case when sensor suite 26 emits an output signal which indicates a movement of motor vehicle 8. Alternatively, the state of operating control elements 22, 24 may also be monitored. Upon actuation of one of operating control elements 22, 24, a critical situation may be inferred, since the steering wheel was already locked. To make the user aware of this critical situation, in step 153, indicator unit 20 is triggered along the lines of a warning. Alternatively, the steering wheel lock may also be canceled.

What is claimed is:

1. A device for the keyless operation of a motor vehicle (8), having a transponder (14) which transmits a code to at least one transceiver (12), and having a control unit (10) which compares the code to an expected code, and upon agreement, enables at least one component (16, 18), and in the shutdown state of the motor vehicle (8), deactivates at least one component (16, 18) necessary for the operation of the motor vehicle (8), wherein at least one timer (T2, T3) is provided, whose output value is compared to a specifiable time duration (t2, t3), the at least one component (16, 18) necessary for the operation of the motor vehicle (8) being deactivated when the output value of the timer (T2, T3) exceeds the specifiable time duration (t2, t3).

2. The device as recited in claim 1, wherein the timer (T2, T3) is started as a function of a sensor signal from a sensor (26) detecting the state of the driving engine of the motor vehicle (8).

3. The device as recited in one of the preceding claims, wherein the timer (T2, T3) is started when the driving engine of the motor vehicle (8) is stopped.

4. The device as recited in one of the preceding claims, wherein the timer (T2, T3) is started as a function of the state of an operating control element (22, 24).

5. The device as recited in one of the preceding claims, wherein the operating control element (22, 24) is a starter switch and/or ignition switch of the motor vehicle (8).

6. The device as recited in one of the preceding claims, wherein for deactivating the component (16, 18) necessary for the operation of the motor vehicle (8), the control unit (10) sends a corresponding command to it.

7. The device as recited in one of the preceding claims, wherein the component (16, 18) necessary for the operation of the motor vehicle (8) is a function control unit (18) such as an engine control unit.

8. The device as recited in one of the preceding claims, wherein the component (16, 18) necessary for the operation of the motor vehicle (8) is a steering wheel lock (16) which locks the steering wheel in response to a deactivation.

9. The device as recited in one of the preceding claims, wherein a deactivation of the component (16, 18) necessary for the operation of the motor vehicle (8) is forestalled when an operating control element (22, 24) is actuated, and the output value of the timer (T2, T3) has not yet exceeded the specifiable time duration (t2, t3).
